(19) United States
(12) Patent Application Publication
(10) Pub. No.: US 2006/0158999 A1
(43) Pub. Date: Jul. 20, 2006

(54) Record carrier with two ecc block sizes, and recording method and recorder for recording such record carrier

(76) Inventor: Martinus Wilhelmus Blum, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/561,852

(22) PCT Filed: Jun. 23, 2004
(86) PCT No.: PCT/IB04/50981

§ 371 Date: Dec. 21, 2005

(30) Foreign Application Priority Data
Jun. 26, 2003 (EP) 031019128

(51) Int. Cl. G11B 7/24; G11B 5/09

(52) U.S. Cl. 369/275.1; 369/59.1; 369/47.1

(57) ABSTRACT

On a small record carrier the inner section of the record carrier represents a significant amount of storage capacity. A regular ECC block however occupies more than one revolution of the record carrier leading to multiplication of burst errors in a single ECC block. By using two ECC block sizes the multiplication of burst errors is prevented. The transition from the small ECC blocks in the inner annular section to the large ECC blocks in the outer annular section of the disk is positioned where one ECC block from the outer annular section occupies one revolution of the record carrier. Thus an optimum division is achieved between large and small ECC blocks optimizing storage capacity and error correction capabilities.

The invention relates to a record carrier comprising a first annular section with an outer perimeter comprising an first ECC block with a size and a second annular section with an inner perimeter adjacent to the outer perimeter of the first annular section, the second annular section comprising a second ECC block with a size where the size of the second ECC block is larger than the size of the first ECC block.

Such a record carrier is known from WO01/93262 where a record carrier is disclosed that comprises annular regions on a circular record carrier with different size ECC blocks. The objective of WO01/93262 is to use the available storage capacity of the small record carrier more efficiently.

This is achieved by reducing the size of ECC blocks in regions where data is stored in units smaller than the regular ECC block. An example of this is the file system attribute area and linking sectors, which contain relatively few bytes. The main file system area is located at the outer perimeter of the record carrier while a copy of the file system area is stored near the center of the record carrier.

The main user data area is located between these two files system areas and uses the regular size ECC blocks.

This record carrier has the disadvantage that the amount of file system information determines the size of the annular region with the smaller ECC blocks. The error correction capabilities of the smaller ECC blocks is reduced compared to the larger ECC blocks. The addition of extra error correction capabilities reduces increases the overhead and reduces the amount of information that can be stored in the annular region with the small ECC blocks.

It is an objective of the present invention to use the available area on the record carrier optimally, yet provide appropriate error correction capabilities for the small ECC blocks.

To achieve this objective the record carrier is characterized in that the outer perimeter of the first annular section is located where the size of the second ECC block is equal to a length of the inner perimeter of the second annular section.

When large ECC blocks are used in the first annular section near the center of the record carrier one ECC block will occupy more than one revolution of the record carrier. This can result in two burst errors in the same ECC block originating from the same surface defect, finger print or dust speck.

This effectively halves the error corrective capabilities for the ECC block. However, if the ECC block size is for instance halved, the error corrective capabilities are also halved.

By positioning the transition from the first annular section to the second annular section there where exactly one second ECC block fits on the inner perimeter of the second annular section the area comprising the large ECC blocks is as large as possible without invoking reductions in the error correction capabilities in that section of the record carrier.

If the transition would be chosen closer to the center of the record carrier the large ECC block would occupy more than one revolution on the record carrier. This results in an overlap of the ECC block, i.e. a section of the ECC block is directly adjacent to another section of the same ECC block.

If a fingerprint or dust speck is located in the area of the overlap, the ECC block experiences two burst errors instead of just one. This reduces the error correction capabilities of the ECC block.

If the transition would be chosen further away from the center of the record carrier the inefficiency of the smaller ECC blocks because of their smaller size would unnecessarily be expanded into the area of the record carrier where the larger ECC blocks would provide more efficient error correction capabilities and would not suffer from the doubling of the burst errors because one large ECC block does not occupy more than one revolution.

Consequently, positioning the transition there where one large ECC block fits exactly on the inner perimeter of the second annular section results in an optimum balance between error correction capabilities and storage efficiency.

A further embodiment of the record carrier is characterized in that the first ECC block is stored using a first error correcting code and the second ECC block is stored using a second error correcting code and that the first error correcting code provides a error correction capability equal to the second error correcting code.

In order to provide equal error correction capabilities to the first and second annular section of the record carrier the small ECC blocks are recorded using more redundancy because of increased overhead.

This reduces the available storage capacity but this reduction is limited by the optimum choice of the transition from the first annular section to the second annular section.

A method for recording information on a record carrier comprising the steps of
recording an ECC Block in a first annular section with an outer perimeter using a first ECC block size and
recording an ECC block in a second annular section with an inner perimeter adjacent to the outer perimeter of the first annular section, using a second ECC block size where the second ECC block size is larger than the first ECC block size, is characterized in that the outer perimeter of the first annular section is located where the second ECC block size is equal to a length of the inner perimeter of the second annular section.

When large ECC blocks are used in the first annular section near the center of the record carrier one ECC block will occupy more than one revolution of the record carrier. This can result in two burst errors in the same ECC block originating from the same surface defect, finger print or dust speck. This effectively halves the error corrective capabilities for the ECC block. However, if the ECC block size is for instance halved, the error corrective capabilities are also halved.

By positioning the transition from the first annular section to the second annular section there where exactly one second ECC block fits on the inner perimeter of the second annular section the area comprising the large ECC blocks is as large as possible without invoking reductions in the error correction capabilities in that section of the record carrier.

If the transition would be chosen closer to the center of the record carrier the large ECC block would occupy more than one revolution on the record carrier. This results in an overlap of the ECC block, i.e. a section of the ECC block is directly adjacent to another section of the same ECC block.

If a fingerprint or dust speck is located in the area of the overlap, the ECC block experiences two burst errors instead of just one. This reduces the error correction capabilities of the ECC block

If the transition would be chosen further away from the center of the record carrier the inefficiency of the smaller ECC blocks because of their smaller size would unnecessarily be expanded into the area of the record carrier where the larger ECC blocks would provide more efficient error correction capabilities and would not suffer from the doubling of the burst errors because one large ECC block does not occupy more than one revolution.

Consequently, positioning the transition there where one large ECC block fits exactly on the inner perimeter of the second annular section results in an optimum balance between error correction capabilities and storage efficiency.

An embodiment of the method is characterized in that the ECC block in the first annular section is recorded using a first error correction code and the ECC block in the second annular section is recorded using a second error correction code and that the first error correcting code provides a error correction capability equal to the second error correction code.

In order to provide equal error correction capabilities to the first and second annular section of the record carrier the small ECC blocks are recorded using more redundancy because of increased overhead.

This reduces the available storage capacity but this reduction is limited by the optimum choice of the transition from the first annular section to the second annular section.

A recorder for recording information on a record carrier comprising a first annular section with an outer perimeter comprising an first ECC block with a size and a second annular section with an inner perimeter adjacent to the outer perimeter of the first annular section, the second annular section comprising a second ECC block with a size where the size of the second ECC block is larger than the size of the first ECC block, the recorder comprising error correction means coupled to processor means coupled to writing means characterized in that the processor means is operative to position the outer perimeter of the first annular section where the second ECC block size is equal to a length of the inner perimeter of the second annular section by providing ECC blocks to the writing means

When the recorder writes large ECC blocks to the first annular section near the center of the record carrier one ECC block will occupy more than one revolution of the record carrier. This can result in a playback device, for instance the one incorporated in the recorder, encountering two burst errors when, in the same ECC block originating from the same surface defect, finger print or dust speck. This effectively halves the error corrective capabilities of the playback device for correcting the ECC block.

However, if the ECC block size is for instance halved as in WO01/93262, the error corrective capabilities are also halved.

When the recorder positions the transition from the first annular section to the second annular section there where exactly one second ECC block fits on the inner perimeter of the second annular section, the area comprising the large ECC blocks is as large as possible without invoking reductions in the error correction capabilities in that section of the record carrier.

If the transition would be positioned closer to the center of the record carrier by the recorder, the large ECC block would occupy more than one revolution on the record carrier. This results in an overlap of the ECC block, i.e. a section of the ECC block is directly adjacent to another section of the same ECC block.

If a fingerprint or dust speck is located in the area of the overlap, the ECC block experiences two burst errors instead of just one. This reduces the error correction capabilities of the ECC block.

If the recorder would locate the transition further away from the center of the record carrier the inefficiency of the smaller ECC blocks because of their smaller size would unnecessarily be expanded into the area of the record carrier where the larger ECC blocks would provide more efficient error correction capabilities and would not suffer from the doubling of the burst errors because one large ECC block does not occupy more than one revolution.

Consequently, positioning the transition there where one large ECC block fits exactly on the inner perimeter of the second annular section results in an optimum balance between error correction capabilities and storage efficiency.

The processing means provide information to the error correction means about where the ECC block will be recorded on the record carrier. Based on this information the error correction means will apply the appropriate error correcting code to the ECC block and provide the ECC block comprising the error correction to the processor means, which in turn provides the ECC block to the writing means together with an indication where to record the ECC block on the record carrier. The writing means subsequently performs the actual recording of the ECC block on the indicated position on the record carrier. The record carrier for instance comprises a wobble embedded into a groove on the record carrier to provide addressing information to the writing means. The writing means is thus able to locate the indicated position for recording on the record carrier.

An embodiment of the recorder is characterized in that the processor are arranged to receive an first ECC block with a first error correction code from the error correction means when recording the first ECC block in the first annular section and processor means is further arranged to receive a second ECC block with a second error correction code from the error correction means when recording the second ECC block in the second annular section and that the error correction capability of the first error correction code is equal to the second error correcting code.

In order to provide equal error correction capabilities to the first and second annular section of the record carrier the small ECC blocks are recorded using more redundancy because of increased overhead.

This reduces the available storage capacity but this reduction is limited by the optimum choice of the transition from the first annular section to the second annular section.

The invention will now be described based on figures.

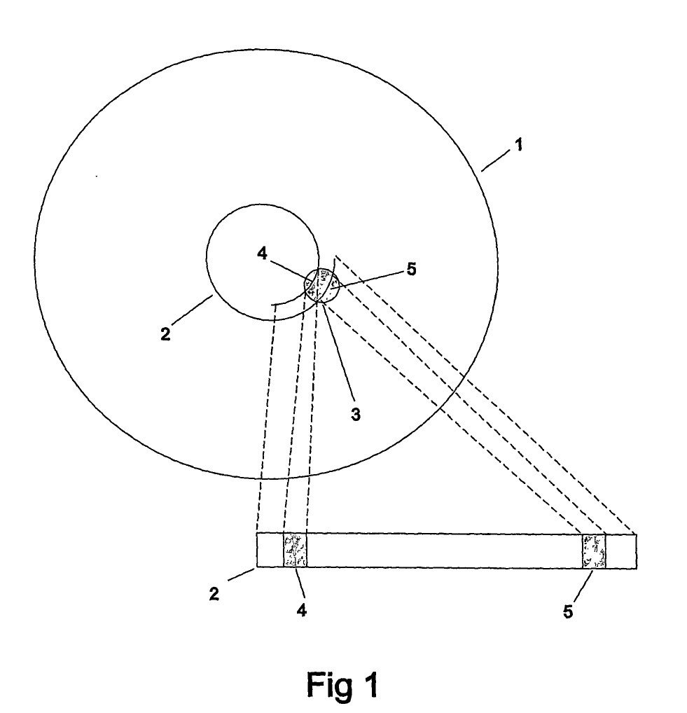

FIG. 1 shows the overlap and the resulting double burst error in the prior art

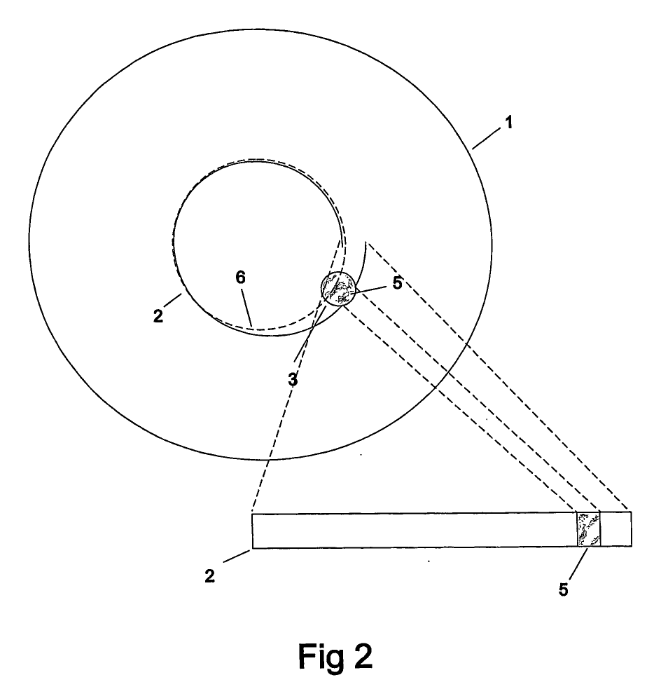

FIG. 2 shows the record carrier an ECC block size of the present invention.

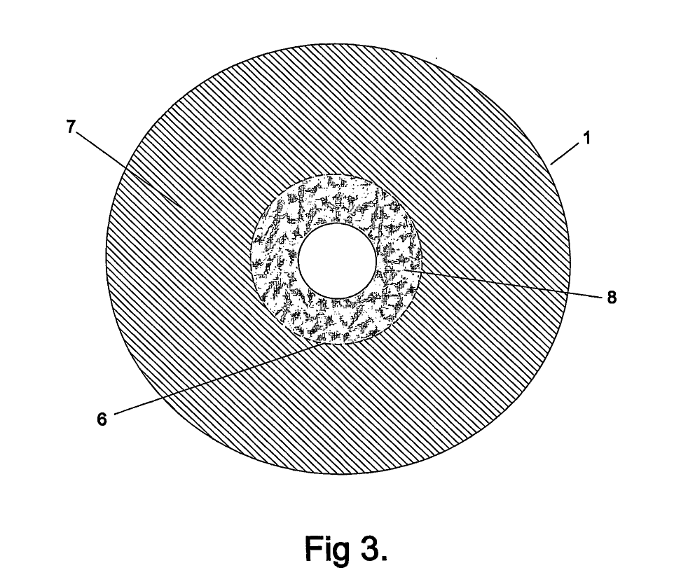

FIG. 3 shows the division into a first and a second annular section.

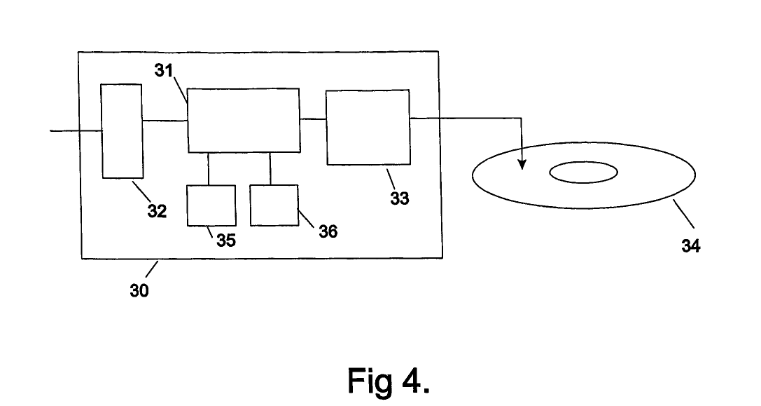

FIG. 4 shows a recorder.

FIG. 1 shows the overlap and the resulting double burst error in the prior art. A record carrier 1 comprises an ECC block 2. The ECC block 2 is positioned at a certain radius from the center and is longer than a circle at the same radius, i.e. a first section 4 of the ECC block is adjacent to a second section 5 of the ECC block.

A surface contamination or surface damage is located in a region 3 covering both sections 4, 5, can result in a burst error in both the first section 4 and second section 5. Hence two burst errors will result in one ECC block.

An error correction code has a certain error correction capability, i.e. the number of correctable errors is limited. If two burst errors occur in an ECC block, the error correction code must handle both burst errors and hence less error correction capacity remains for other errors in the ECC word, compared to the situation that only a single burst error occurs.

FIG. 1 shows the ECC block 2 both physically located on the record carrier with a circular shape, and as a linear representation showing the result of the overlap on the location of the burst errors in the ECC block 2. The first burst error in the first section is located near the start of the ECC block while the second burst error in the second section 5 is located near the end of the ECC block in this example.

FIG. 2 shows the record carrier an ECC block size of the present invention. The ECC block 2 in FIG. 2 is of the same size as the ECC block 2 in FIG. 1 but is located further away from the center of the record carrier 1. Consequently there is no longer an overlap between sections of the ECC block 2. A surface contamination 5 or record carrier damage will no longer cause two burst errors in one ECC block 2 but only a single burst error in a single section 5 of the ECC block 2, enabling more errors to be corrected with the same error correcting code.

FIG. 2 shows the situation where the ECC block 2 fits exactly in a single revolution of the record carrier. A circle 6 indicates the position on the record carrier where this is the case. ECC blocks outside this circle 6 are to be recorded using the large ECC block size while ECC blocks inside the circle 6 are to be recorded using the small ECC block size. This allows the prevention of the formation of double burst errors by a single surface contamination or record carrier damage. The small ECC blocks recorded inside the circle 6 can be protected using an error correction code which offers better error correction capabilities. A proposal for this error correction code is outlined below under ‘Dual format ECC error correction implementation’.

FIG. 3 shows the division into a first and a second annular section. It is desirable to store as much data on a record carrier as possible. Limitations to the amount of data which can be stored on a record carrier are the data density, the maximum outer diameter of the writeable area and the minimum inner diameter of the writeable area. The maximum outer diameter is limited by the diameter of the record carrier. The minimum inner diameter is limited by the clamping area needed to clamp the record carrier on the spindle. For a given record carrier size with a given data density it is thus desirable to record as close as possible to the center of the record carrier. This is especially true for record carriers with a small diameter. While on a regular DVD, Blue disc or CD the inner section close to the clamping are can be neglected since any gain represents a small percentage of record carrier storage capacity. On a small disc however the inner section close to the clamping area represents a significant percentage of the total record carrier storage capacity.

In FIG. 3 the record carrier 1 comprises a first annular section 8 and a second annular section 7. The first annular section 8 has an inner perimeter and an outer perimeter 6. The second annular section 7 has an inner perimeter essentially coinciding with the outer perimeter of the first annular section. Because the ECC block size in the first annular section 8 is smaller than the ECC block size in the second annular section 7 a transition from the first annular section 8 to the second annular section 7 exists this transition can be an abrupt change in ECC block size from one ECC block to another ECC block or can be implemented with an intermediate area which can for instance be left empty. It is thus not essential for the invention that the two annular sections 7, 8 are directly adjacent but in order to maximize the use of the recording area the transition from the first section 8 to the second section 7 should be minimized.

FIG. 4 shows a recorder.

The recorder 30 comprises an interface 32 for receiving commands and data from other devices or higher-level applications, and for providing data from the record carrier and messages from the recorder to other devices and higher-level applications. The interface 32 is coupled to a processor 31 which can be implemented as a micro controller, a microprocessor, or a gate array. The processor 31 handles various tasks of the recorder, for instance data processing, command parsing and control of the basic bit engine 33 and interfacing with the operator via a keyboard and display (not shown). The processor 31 also coordinates the application of the error correction code to the ECC blocks. For this purpose two-error correction means 35, 36 are indicated in FIG. 4. Each error correction means is arranged for providing an error correction code to an ECC block. Depending on where the ECC Block will be written on the record carrier the processor will provide the data for the ECC block to one of the error correction means 35, 36. The error correction means then applies the error correction code to the data and provides an ECC block back to the processor 31. The processor 31 then instructs the writing means, i.e. the basic bit engine 33 to write the ECC block at the specified address on the record carrier 34. In this way the processor can control the size and error correction code of the ECC blocks in the annular sections of the record carrier 34. It is self evident that the error correction means 35, 36 can be implemented in the processor 31 in software or hardware, instead of external to the processor 31. Also a single error correction means able to apply both error correction codes to data blocks can be used instead of two error correction means 35,36.

Dual Format ECC Error Correction Implementation

The ECC scheme that can be employed contains two types of ECC blocks:

1. The Blu-ray Disc error correction block
2. An error correction block that is shorter than the first one can contain 32 Kbytes of data, with more overhead than the first one, but with similar error correction capabilities.

The first ECC block is used at the outer side of the disc, the second ECC block at the inner side of the disc. The switch takes place at the radius where the circumvention of the disc is equal to the length of one Blu-ray Disc ECC block.

Inner Radius ECC Block Description

The terminology used is similar to the terminology used in the Blu-ray Disc system description.

The frames of the new error correction format are equal to the frames in the BD error correction format: 152 LDC bytes and 3 BIS-bytes.

Data Block:

The data block is formed by putting 16 data frames of 2052 bytes each into a 304×108 matrix:

| | 304 columns | | | | | | | | | |
|---|---|---|---|---|---|---|---|---|---|---|
| | 0 | 1 | . . . | 18 | 19 | . . . | 37 | 38 | . . . | 303 |
| 108 | d_{0,0} | d_{108,0} | . . . | d_{1944,0} | d_{0,1} | . . . | d_{1944,1} | d_{0,2} | . . . | d_{1944,15} |
| rows | d_{1,0} | d_{109,0} | . . . | d_{1945,0} | d_{1,1} | . . . | d_{1945,1} | d_{1,2} | . . . | d_{1945,15} |
| | . . . | . . . | . . . | . . . | . . . | . . . | . . . | . . . | . . . | . . . |
| | . . . | . . . | . . . | . . . | . . . | . . . | . . . | . . . | . . . | . . . |
| | . . . | . . . | . . . | . . . | . . . | . . . | . . . | . . . | . . . | . . . |
| | . . . | . . . | . . . | . . . | . . . | . . . | . . . | . . . | . . . | . . . |
| | . . . | . . . | . . . | . . . | . . . | . . . | . . . | . . . | . . . | . . . |
| | . . . | . . . | . . . | . . . | . . . | . . . | . . . | . . . | . . . | . . . |
| | . . . | . . . | . . . | . . . | . . . | . . . | . . . | . . . | . . . | . . . |
| | d_{107,0} | e_{215,0} | . . . | d_{2051,0} | d_{107,1} | . . . | d_{2051,1} | d_{107,2} | . . . | d_{2051,15} |

LDC Block:

The LDC block is formed by adding 32 parity symbols to each column of the Data block.

| | | 304 columns | | | | | | |
|---|---|---|---|---|---|---|---|---|
| | | codeword 0 | codeword 1 | . . . | codeword L | . . . | codeword 302 | codeword 303 |
| 1 LDC | 108 | e_{0,0} | e_{0,1} | . . . | e_{0,L} | . . . | e_{0,302} | e_{0,303} |
| codeword = | rows | e_{1,0} | e_{1,1} | . . . | e_{1,L} | . . . | e_{1,302} | e_{1,303} |
| 140 bytes | with | e_{2,0} | . . . | . . . | . . . | . . . | . . . | . . . |
| | data | . . . | . . . | . . . | . . . | . . . | . . . | . . . |
| | | . . . | . . . | . . . | . . . | . . . | . . . | . . . |
| | | e_{107,0} | e_{107,1} | . . . | e_{107,L} | . . . | e_{107,302} | e_{107,303} |
| | 32 | p108,0 | p108,1 | . . . | p108,L | . . . | P108,302 | p108,303 |
| | rows | . . . | . . . | . . . | . . . | . . . | . . . | . . . |
| | with | . . . | . . . | . . . | . . . | . . . | . . . | . . . |
| | parity | . . . | . . . | . . . | . . . | . . . | . . . | . . . |
| | | . . . | . . . | . . . | . . . | . . . | . . . | . . . |
| | | P139,0 | p139,1 | . . . | P139,L | . . . | P139,302 | p139,303 |

An LDC-cluster is formed from this LDC block in two interleaving steps:
First Interleaving Step:

In the first interleaving step two columns of the LDC Data block are merged in to one column of the LDC cluster in the following way:

| | 152 columns | | | | | |
|---|---|---|---|---|---|---|
| | 0 | 1 | . . . | . . . | 151 | |
| 216 | e_{0,0} | e_{0,2} | . . . | . . . | e_{0,302} | 279 |
| rows | | | . . . | . . . | | rows |
| with | e_{1,0} | e_{1,2} | . . . | . . . | e_{1,302} | |
| data | | | . . . | . . . | | |
| | . . . | . . . | . . . | . . . | . . . | |
| | . . . | . . . | . . . | . . . | . . . | |
| | e_{107,0} | e_{107,2} | . . . | . . . | e_{107,302} | |
| 63 | p108,0 | p108,2 | . . . | . . . | e_{108,302} | |
| rows | | | . . . | . . . | | |
| with | . . . | . . . | . . . | . . . | . . . | |
| parity | . . . | . . . | . . . | . . . | . . . | |
| | P138,0 | P138,2 | . . . | . . . | e_{138,302} | |
| | | | . . . | . . . | | |
| | P139,0 | P139,2 | . . . | . . . | e_{139,302} | |

Note that the last symbol of each odd codeword of the LDC block is not used!

Second Interleaving Step
In the second interleaving step the rows are shifted cyclically to the left in groups of two rows. The shift is increased by 3 for each group of rows, starting with shift 0 for the first two rows. This is almost equal to the second interleaving step of the BD format.
BIS—Columns
Each row of the ECC block contains 3 BIS-columns. The 279 rows of the ECC block are divided into 9 addressing units of 31 rows each. The first three rows of each unit in the BIS-cluster contain the 9-byte Address fields. The remaining rows contain the user control bytes (UC-bytes, 16×18 bytes) and the parity bytes (18×26 bytes).

User Control Data Units:

| | 16 units | | | | | |
|---|---|---|---|---|---|---|
| | 0 | 1 | . . . | S | . . . | 31 |
| 18 bytes | UC_{0,0} | UC_{0,1} | . . . | UC_{0,S} | . . . | UC_{0,31} |
| | UC_{1,0} | UC_{1,1} | . . . | . . . | . . . | UC_{1,31} |
| | . . . | . . . | . . . | . . . | . . . | . . . |
| | . . . | . . . | . . . | . . . | . . . | . . . |
| | UC_{17,0} | UC_{17,1} | . . . | UC_{17,S} | . . . | UC_{17,31} |

Address Fields:

| | 9 addresses | | | | | |
|---|---|---|---|---|---|---|
| | 0 | 1 | . . . | S | . . . | 8 |
| 9 bytes | AF_{0,0} | AF_{0,1} | . . . | AF_{0,S} | . . . | AF_{0,31} |
| | . . . | . . . | . . . | . . . | . . . | . . . |
| | . . . | . . . | . . . | . . . | . . . | . . . |
| | AF_{8,0} | AF_{8,1} | . . . | AF_{8,S} | . . . | AF_{8,31} |

The BIS-columns are formed by interleaving nine RS (47,21,27) codewords (0 . . . 8) and nine RS (46,20,27) codewords (9 . . . 17):

BIS-cluster:

| | | | | |
|---|---|---|---|---|
| | | [symbol] | 3 BIS | → |
| | | | columns | |
| | | 0 | 1 | 2 |
| ↑ | ↑ | b_{x,0} | b_{x,1} | b_{x,2} |
| | | b_{x,3} | b_{x,4} | b_{x,5} |
| | | : | : | : |
| | | : | : | : |
| | 31 | : | : | : |
| | rows | b_{x,15} | b_{x,16} | b_{x,17} |
| | (A.U.) | b_{x,0} | b_{x,1} | b_{x,2} |
| | | : | : | : |
| | | : | : | : |
| | ↓ | b_{x,0} | b_{x,1} | b_{x,2} |
| | ↑ | b_{x,3} | b_{x,4} | b_{x,5} |
| 9 | | : | : | : |
| address | 31 | : | : | : |
| units | rows | : | : | : |
| = | (A.U.) | : | : | : |
| 279 | | : | : | : |
| rows | ↓ | : | : | : |
| | : | : | : | : |
| | : | : | : | : |
| | : | : | : | : |
| | ↑ | : | : | : |
| | | : | : | : |
| | 31 | : | : | : |
| | rows | : | : | : |
| | | : | : | : |
| ↓ | ↓ | b_{x,6} | b_{x,7} | b_{x,8} |

In each address unit, the rows will be shifted cyclically to the left in groups of three rows. For each subsequent group the shift is increased by 1, starting with shift 0 for the first group of three rows. Note that this shift is not shown in the figure of the BIS-cluster.

1. Record carrier comprising a first annular section with an outer perimeter comprising an first ECC block with a size and a second annular section with an inner perimeter adjacent to the outer perimeter of the first annular section, the second annular section comprising a second ECC block with a size where the size of the second ECC block is larger than the size of the first ECC block,
characterized in that the outer perimeter of the first annular section is located where the size of the second ECC block is equal to a length of the inner perimeter of the second annular section.

2. Record carrier as claimed in claim 1,
characterized in that the first ECC block is stored using a first error correction code and the second ECC block is stored using a second error correction code and that the first error correction code provides a error correction capability equal to the second error correction code.

3. Method for recording information on a record carrier comprising the steps of
recording an ECC Block in a first annular section with an outer perimeter using a first ECC block size and
recording an ECC block in a second annular section with an inner perimeter adjacent to the outer perimeter of the first annular section, using a second ECC block size where the second ECC block size is larger than the first ECC block size,
characterized in that the outer perimeter of the first annular section is located where the second ECC block size is equal to a length of the inner perimeter of the second annular section.

4. Method as claimed in claim 3,
characterized in that
the ECC block in the first annular section is recorded using a first error correction code and the ECC block in the second annular section is recorded using a second error correction code and that the first error correcting code provides a error correction capability equal to the second error correction code.

5. Recorder for recording information on a record carrier comprising a first annular section with an outer perimeter comprising an first ECC block with a size and a second annular section with an inner perimeter adjacent to the outer perimeter of the first annular section, the second annular section comprising a second ECC block with a size where the size of the second ECC block is larger than the size of the first ECC block, the recorder comprising error correction means coupled to processor means coupled to writing means characterized in that the processor means is operative to position the outer perimeter of the first annular section where the second ECC block size is equal to a length of the inner perimeter of the second annular section by providing ECC blocks to the writing means

6. Recorder as claimed in claim 5,
characterized in that
the processor are arranged to receive an first ECC block with a first error correction code from the error correction means when recording the first ECC block in the first annular section and processor means is further arranged to receive a second ECC block with a second error correction code from the error correction means when recording the second ECC block in the second annular section and that the error correction capability of the first error correction code is equal to the second error correcting code.
